(19) United States
(12) Patent Application Publication
(10) Pub. No.: US 2016/0036080 A1
(43) Pub. Date: Feb. 4, 2016

(54) SYSTEM FOR FUEL CELL VEHICLE

(71) Applicant: Hyundai Motor Company, Seoul (KR)

(72) Inventors: Sang Eun Jang, Uijeongbu (KR); Il Hee Cho, Seongnam (KR); Yei Sik Jeon, Seoul (KR); Jong Hyun Lee, Yongin (KR)

(21) Appl. No.: 14/542,617

(22) Filed: Nov. 16, 2014

(30) Foreign Application Priority Data
Jul. 30, 2014 (KR) 10-2014-0097541

(51) Int. Cl. H01M 8/06; C25B 1/04

(52) U.S. Cl. CPC H01M 8/0656; C25B 1/04; H01M 2250/20

(57) ABSTRACT

A system for a fuel cell vehicle is provided. The system includes an electrolytic cell installed to react residual hydrogen or oxygen within a stack when a fuel cell starts up and is shut down instead of an auxiliary resistor mounted on an exterior of a stack, thereby increasing stack durability. Particularly, the system for the fuel cell vehicle includes a stack unit of a fuel cell and an electrolytic cell unit configured to store energy in the form of hydrogen or oxygen.

### CROSS-REFERENCE TO RELATED APPLICATION

This application is based on and claims the benefit of priority to Korean Patent Application No. 10-2014-0097541, filed on Jul. 30, 2014 in the Korean Intellectual Property Office, the disclosure of which is incorporated herein in its entirety by reference.

### TECHNICAL FIELD

The present invention relates to a system for a fuel cell vehicle. The system includes an electrolytic cell which is installed to residual hydrogen or oxygen within a stack when a fuel cell starts up and is shut down, thereby increasing stack durability.

### BACKGROUND

Recently, various environment-friendly electric vehicles have been developed in attempt to reduce energy consumption and environmental pollution. Among those vehicles, fuel cell vehicles and hybrid vehicles may be representative examples.

A fuel cell vehicle refers to a vehicle that uses electric energy generated from an electrochemical reaction between hydrogen and oxygen as power source. A hybrid vehicle refers to a vehicle that uses an internal combustion engine when running at a substantially high speed and when running on an uphill road and uses electric energy as a power source when running at a substantially low speed or stopped. In general, the existing internal combustion engine vehicle obtains driving power by explosively reacting fossil fuel and oxygen in the air within an engine to convert chemical energy into mechanical energy. On the other hand, a fuel cell vehicle is driven using electrical energy generated by electrochemical reaction with hydrogen supplied through a high-pressure hydrogen tank or a reformer and oxygen in the air supplied through an air turbo compressor within a fuel cell stack.

A fuel cell system refers to a system which directly converts energy of fuel into electrical energy. In the fuel cell system, a pair of anode and cathode is disposed with an electrolyte interposed therebetween and electricity and heat are obtained through electrochemical reaction of an ionized fuel gas. Among the fuel cell system, a polyelectrolyte fuel cell which has a substantially high current density, a substantially low operating temperature, a substantially low degree of corrosion, and a substantially low amount of loss of electrolyte has been originally developed as power source for a military use or a spacecraft. Recently, since a polyelectrolyte fuel cell has been developed to have substantially high output density and to be simply modularized, application thereof as a power source for a vehicle has been actively conducted. In the related art, an interface of hydrogen and air is formed in a hydrogen electrode within a stack, and an electrochemical cell of hydrogen and air is formed bordering the interface when a fuel cell stack starts up or is shut down. Particularly, an air electrode in contact with hydrogen of the air electrode forms a potential difference ranging from 0 to 0.9 V, and the air electrode within the hydrogen electrode also forms a potential difference ranging from 0 to 0.9 V. In particular, in such fuel cell stack, high potential ranging from 0 to 1.8 V is formed in an air layer of the air electrode to corrode carbon used as a catalyst support of the electrode, which degrades durability of the stack.

Various factors may degrade durability of a hydrogen fuel cell vehicle, and among the factors, a degradation of the air electrode may influence significantly to degrade durability when a fuel cell system starts up and is shut down. In the current related art, when a fuel cell system starts up and is shut down, a technique has been provided for rapidly removing an interface by quickly supplying hydrogen when a fuel cell system starts up and for removing residual hydrogen or oxygen within a stack using a resistor (COD) when the fuel cell system is shut down to suppress a degradation due to formation of an interface of the hydrogen electrode.

However, such technique in the related art method may consume a current and resistance remaining within a stack using a resistor may need an additional device installed exterior of the stack, and thus an overall volume of the fuel cell system may increase.

The description provided above as a related art of the present invention is merely for helping in understanding the background of the present invention and should not be construed as being included in the related art known by those skilled in the art.

### SUMMARY

The present invention provides technical solutions to technical difficulties in the related arts.

In one aspect, the present invention provides a system for a fuel cell vehicle. The fuel cell system may include an electrolytic cell in which residual hydrogen or oxygen within a stack may be entirely reacted when a fuel cell starts up and is shut down, thereby increasing stack durability.

According to an exemplary embodiment of the present invention, a system for a fuel cell vehicle may include: a stack unit of a fuel cell; and an electrolytic cell unit. The electrolytic cell unit be configured to electrolyze water using energy generated by reacting residual hydrogen or oxygen within the stack unit, and store energy in the form of hydrogen and oxygen. The electrolytic cell unit may include: a hydrogen capturing unit configured to store hydrogen; and an oxygen capturing unit configured to store oxygen. The electrolytic cell unit may further include: a hydrogen supplier configured to receive hydrogen from the hydrogen capturing unit and provide the received hydrogen to the stack unit.

In addition, the electrolytic cell unit may include: an oxygen supplier configured to receive oxygen from the oxygen capturing unit and provide the received oxygen to the stack unit. The electrolytic cell unit may be configured to electrolyze water using regenerative braking energy generated when a fuel cell vehicle is decelerated and stopped, and store the energy in the form of hydrogen and oxygen. The stack unit may include a stack discharge water capturing unit configured to capture water discharged from the stack unit and supply the water to the electrolytic cell unit.

### BRIEF DESCRIPTION OF THE DRAWINGS

The above and other objects, features and advantages of the present invention will be more apparent from the following detailed description taken in conjunction with the accompanying drawings.

FIG. 1 illustrates an exemplary system for an exemplary fuel cell vehicle according to an exemplary embodiment of the present invention;

FIG. 2 illustrates an exemplary major part to show a flow of energy generated when an exemplary fuel cell system in FIG. 1 starts up and is shut down according to an exemplary embodiment of the present invention;

FIG. 3 illustrates an exemplary major part to show supply path of hydrogen and oxygen to a stack when an exemplary fuel cell vehicle runs an uphill road at an elevated speed and an output is reduced according to an exemplary embodiment of the present invention; and

FIG. 4 illustrates an exemplary major part to show a flow of energy generated when an exemplary fuel cell vehicle is decelerated and stopped according to an exemplary embodiment of the present invention;

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a fuel cell vehicle is a vehicle which includes a fuel cell system for sources of power and uses electric energy generated from the fuel cell system.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

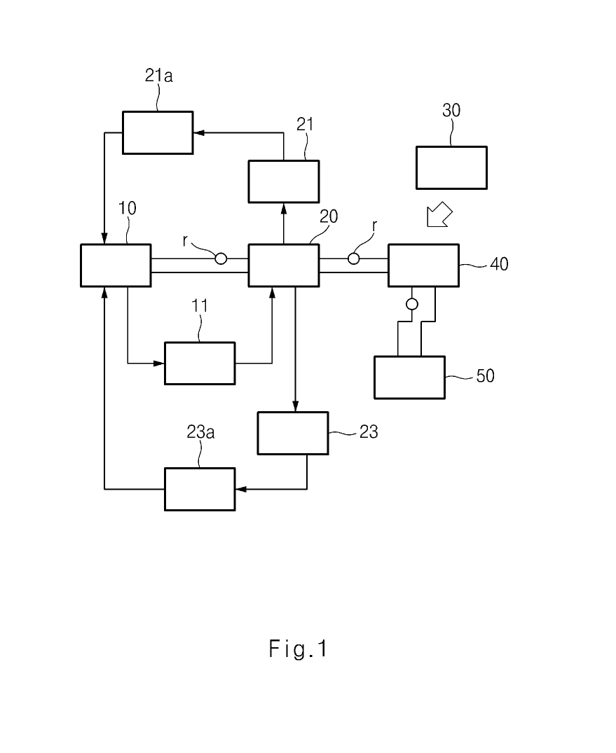

FIG. 1 schematically illustrates an exemplary system for an exemplary fuel cell vehicle according to an exemplary embodiment of the present invention. As illustrated in FIG. 1, an exemplary system for a fuel cell vehicle may include: a stack unit 10 of a fuel cell and an electrolytic cell unit 20 configured to electrolyze water. The electrolytic cell unit 20 may use energy generated by reacting residual hydrogen or oxygen within the stack unit 10 when the fuel cell starts up and is shut down, and store the energy in the form of hydrogen and oxygen. In particular, a relay member r may be installed between the stack unit 10 and the electrolytic cell unit 20 to adjust movement of energy, which is generated when any one of residual hydrogen and oxygen within the stack unit 10 is consumed, to the electrolytic cell unit 20.

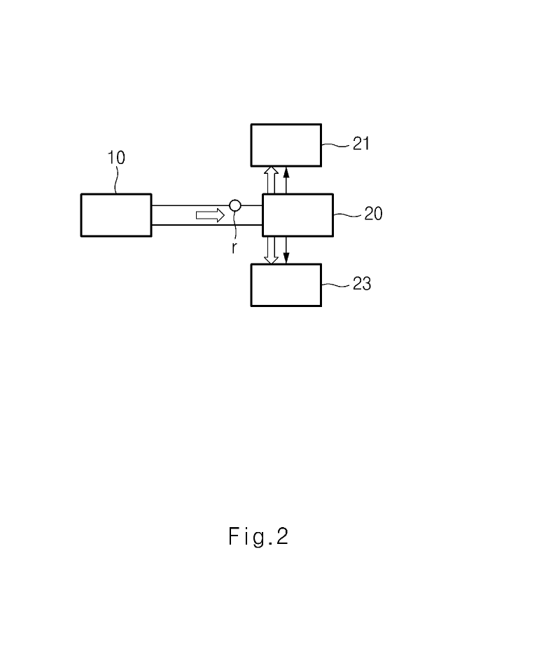

FIG. 2 illustrates an exemplary major part to show a flow of energy generated when the fuel cell system in FIG. 1 starts up and is shut down. As illustrated in FIG. 2, the electrolytic cell unit 20 may be connected to a hydrogen capturing unit 21 to store the hydrogen and an oxygen capturing unit 23 for storing the oxygen. In FIG. 2, a flow path of energy is illustrated with white arrows. When hydrogen or oxygen which is consumed in the stack unit 10, the energy generated in the stack unit 10 may move to the electrolytic cell unit 20, and water may be electrolyzed using the energy and stored in the form of hydrogen and oxygen.

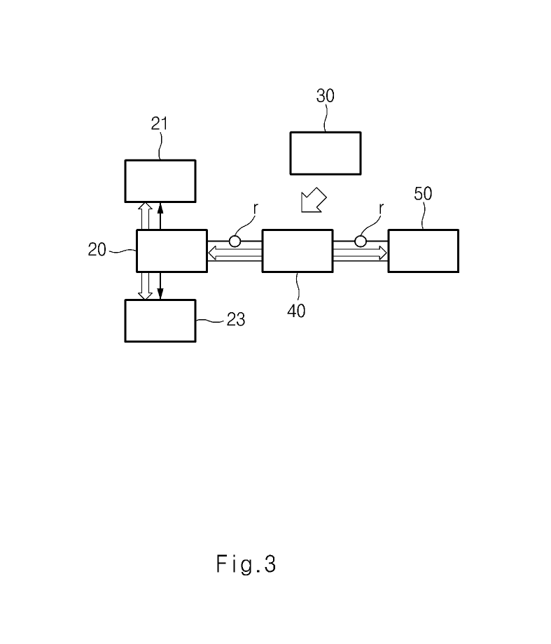

FIG. 3 illustrates an exemplary major part from FIG. 1 to show a supply path of hydrogen and oxygen to a stack when the fuel cell vehicle runs an uphill road at a high speed and an output is lowered. As illustrated in FIG. 3, the hydrogen capturing unit 21 may be configured to supply the stored hydrogen to the stack unit 10 to increase fuel efficiency or mileage of the fuel cell vehicle. In particular, the hydrogen capturing unit 21 and the stack unit 10 may be connected by a hydrogen supplier 21a, such that the hydrogen of the hydrogen capturing unit 21 may be provided to the stack unit 10 through the hydrogen supplier 21a. In addition, the oxygen capturing unit 23 may be configured to supply high concentration oxygen stored therein to the stack unit 10 to increase an output of a fuel cell. The oxygen capturing unit 23 and the stack unit 10 may be connected by an oxygen supplier 23a, such that oxygen of the oxygen capturing unit 23 may be provided to the stack unit 10 through the oxygen supplier 23a.

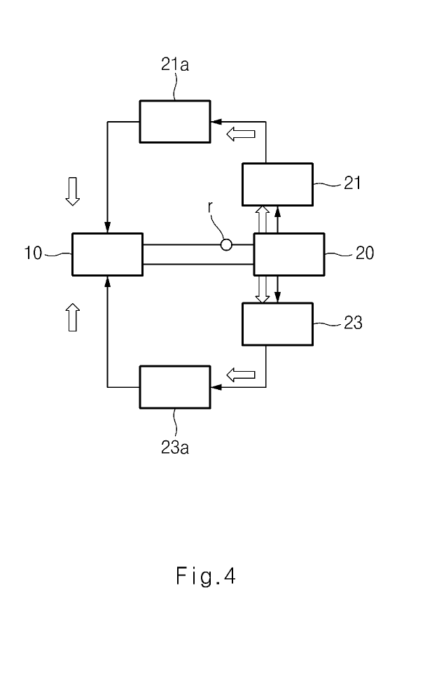

FIG. 4 illustrates an exemplary major part from FIG. 1 to show a flow of energy generated when the fuel cell vehicle is decelerated and stopped. As illustrated in FIG. 4, the electrolytic cell unit 20 may be configured to store regenerative braking energy 30 which may be generated when the fuel cell vehicle is decelerated and stopped in the form of hydrogen and oxygen.

Particularly, the regenerative braking energy 30 may be selectively stored in a high voltage battery 50 by a power conversion system (BHDC) 40 of the fuel cell vehicle or may be stored in the form of oxygen and hydrogen in the electrolytic cell unit 20. The white arrows in FIG. 4 indicate transmission of the regenerative braking energy 30 from the power conversion system 40 to the electrolytic cell unit 20 or the high voltage battery 50. The relay members r may be respectively installed between the power conversion system 40 and the high voltage battery 50 and between the power conversion system 40 and the electrolytic cell unit 20, to adjust storage of the regenerative braking energy 30 in the high voltage battery 50 or the electrolytic cell unit 20 from the power conversion system 40.

In an exemplary embodiment, when the high voltage battery 50 is required to be charged, the regenerative braking energy 30 may be stored in the high voltage battery 50, and when the high voltage battery is not required to be charged, the regenerative braking energy 30 may be stored in the electrolytic cell unit 20 and supply hydrogen and oxygen to the stack unit 10. Meanwhile, when the electrolytic cell unit 20 stores the regenerative braking energy 30 in the form of hydrogen and oxygen, hydrogen may be stored in the hydrogen capturing unit 21 and oxygen may be stored in the oxygen capturing unit 23.

As shown in FIG. 1, water discharged from the stack unit 10 may be used as water to be supplied to the electrolytic cell unit 20. The stack unit 10 may further include a stack discharge water capturing unit 11. The stack discharge water capturing unit 11 may be configured to collect or capture water discharged from the stack unit 10 and supply the water to the electrolytic cell unit 20. Since water discharged from the stack unit 10 may be supplied to the electrolytic cell unit 20, an additional component for supplying water to the electrolytic cell unit 20 from the exterior may be omitted, thereby preventing an increase in the volume of the system for a fuel cell vehicle.

The system for a fuel cell vehicle according to various exemplary embodiments of the present invention as described above may provide technical advantages. For example, when the fuel cell starts up and is shut down, hydrogen or oxygen remaining within a stack may be consumed using the electrolytic cell. Furthermore, energy generated at this time may be used to electrolyze water and the energy may be stored in the form of hydrogen and oxygen. Moreover, the stored hydrogen may be connected to a fuel supply line thereby enhancing fuel efficiency of the system and the stored oxygen may be connected to an air supply line thereby increasing an oxygen rate and enhancing system efficiency. An electrolytic cell may be disposed within a stack module to have a structure substantially identical to that of the related art. However, the volume of the system of the present invention may not increase, and energy may be stored as hydrogen and oxygen with greater efficiency than that of a conventional battery through electrolysis using regenerative braking energy when a vehicle is decelerated or when a fuel cell starts up and is shut down, by using electrolytic cell.

As described above, according to various exemplary system for a fuel battery cell of the present invention, hydrogen or oxygen remaining within a stack when the fuel cell starts up and is shut down may be consumed using the electrolytic cell, such that energy generated at this time may be used to electrolyze water and the energy may be stored in the form of hydrogen and oxygen. In addition, the stored hydrogen may be connected to the fuel supply line to enhance fuel efficiency of the system and the stored oxygen may be connected to an air supply line to increase an oxygen rate to enhance system efficiency.

The system for the fuel cell vehicle according to various exemplary embodiments of the present invention as described above may prevent increase in the volume of the system although an electrolytic cell is disposed within a stack module. Further, by using the electrolytic cell, the system for the fuel cell vehicle may provide greater efficiency in storing energy as hydrogen and oxygen than that of a conventional battery through electrolysis using regenerative braking energy when a vehicle is decelerated as well as when a fuel cell starts up and is shut down.

As described above, although the present disclosure has been described with reference to exemplary embodiments and the accompanying drawings, it would be appreciated by those skilled in the art that the present disclosure is not limited thereto but various modifications and alterations might be made without departing from the scope defined in the following claims.

What is claimed is:

1. A system for a fuel cell vehicle, comprising:
a stack unit of a fuel cell; and
an electrolytic cell unit configured to store energy in the form of hydrogen and oxygen.

2. The system according to claim 1, wherein the electrolytic cell unit includes:
a hydrogen capturing unit configured to store hydrogen; and
an oxygen capturing unit configured to store oxygen.

3. The system according to claim 2, wherein the electrolytic cell unit further includes a hydrogen supplier configured to receive hydrogen from the hydrogen capturing unit and provide the received hydrogen to the stack unit

4. The system according to claim 2, wherein the electrolytic cell unit further includes an oxygen supplier configured to receive oxygen from the oxygen capturing unit and provide the received oxygen to the stack unit.

5. The system according to claim 1, wherein the electrolytic cell unit is configured to store regenerative braking energy generated when a fuel cell vehicle is decelerated and stopped, in the form of hydrogen and oxygen.

6. The system according to claim 1, wherein the stack unit includes a stack discharge water capturing unit configured to capture water discharged from the stack unit and supply water to the electrolytic cell unit.
